(19) United States
(12) Patent Application Publication
(10) Pub. No.: US 2021/0391779 A1
(43) Pub. Date: Dec. 16, 2021

(54) CRYOGENIC COOLING IN ELECTRICAL MACHINES

(71) Applicant: Rolls-Royce Deutschland Ltd & Co KG, Blankenfelde-Mahlow (DE)

(72) Inventors: Stefan Moldenhauer, Ilmenau (DE); Martin Thummet, Neunkirchen am Brand (DE)

(21) Appl. No.: 17/287,509

(22) PCT Filed: Oct. 11, 2019
(86) PCT No.: PCT/EP2019/077647

§ 371 Date: Apr. 21, 2021

(30) Foreign Application Priority Data
Oct. 22, 2018 (DE) 10 2018 218 028.8

(51) Int. Cl. H02K 55/04; H02K 5/20; H02K 9/20; B64D 27/24; B64D 33/08

(52) U.S. Cl. CPC H02K 55/04; H02K 5/203; B64D 2027/026; B64D 27/24; B64D 33/08; H02K 9/20

(57) ABSTRACT

The invention describes a rotor (17) of an electrical machine (13) having a first housing (1) and a second housing (2), which is arranged in the interior of the first housing (1) with a cavity (18) with respect to the first housing (1). A liquid cryogen (9) can be introduced into the second housing (2) through a first opening (4) formed on the second housing (2). The vaporised cryogen (10) can be introduced into the cavity (18) through a second opening (5) formed on the second housing (2). The vaporised cryogen (10) can flow out from the cavity (18) through a third opening (6) formed on the first housing (1). In addition, the invention describes an electrical machine (13), a device for cooling and an aircraft. The invention also relates to an associated method for cooling a rotor (17).

This application is the National Stage of International Application No. PCT/EP2019/077647, filed Oct. 11, 2019, which claims the benefit of German Patent Application No. DE 10 2018 218 028.8, filed Oct. 22, 2018. The entire contents of these documents are hereby incorporated herein by reference.

### FIELD

The present embodiments relate to a rotor, to an electrical machine and to a cryogenic cooling system, and to a device and a method for cooling a rotor of an electrical machine. The present embodiments also relate to an aircraft having such a device for cooling.

### BACKGROUND

High-power hybrid-electric aircraft propulsion units use electrical machines that have a particularly high power density. In order to achieve this, the rotor of the electrical machine contains superconducting materials, which are to be cooled to a temperature of 20-30 K.

It is known to protect a cryogenic rotor from heat input from the surroundings using superinsulation. Such insulation frequently consists of a vacuum gap between two coaxial cylinders and radiation-reflecting films introduced into the gap. In order to avoid thermal bridges, all the connecting elements between the inner cold cylinder and the outer warm cylinder are configured so that the heat input from warm to cold is minimal. A technical problem of this concept is the associated filigree nature of force transmission elements between cold and warm rotor components.

The remaining, unavoidable heat input is compensated for by cooling the inner cold cylinder with a suitable cooling agent (e.g., liquid hydrogen or liquid neon), as is described, for example, in DE 10 2016 213993 A1.

The cooling agent is thereby generally evaporated in the rotor, and the saturated vapor is supplied to a refrigerating machine, where the saturated vapor is recondensed. In the case of a cryogenically cooled rotor for use in aviation, recondensation by a refrigerating machine is unsuitable owing to the high mass of the refrigerating machine. Consequently, for use in aviation, liquid hydrogen as the cold source is transported in the aircraft and used for cooling the cryogenic rotor. Since this cooling is purely evaporative cooling at the evaporating temperature of the hydrogen (about 20 K), the sensible heat of the hydrogen gas remains unused. In addition, a heat source with which the hydrogen may be warmed from the evaporating temperature to the use temperature (e.g., room temperature) is to be provided.

A further disadvantage of this rotor structure is the warming of the rotor outside wall and of the adjoining air gap. As a result of air friction and electromagnetic power loss, which is induced by the stator field into the rotor wall, the outside wall of the rotor warms up and is also to be cooled.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, improved cryogenic cooling of electrical machines used, for example, in hybrid-electric propulsion units in aviation is provided.

According to the present embodiments, a rotor, an electrical machine, a device for cooling, an aircraft, and a method for cooling are provided.

According to the present embodiments, a cryogen evaporated in an interior of an inner housing is guided through a cavity between the inner housing and an outer housing of a rotor of an electrical machine. In the case of cylindrical housings, the cavity may also be referred to as an annular gap.

The rotor may have high-temperature superconducting coils for generating a rotor magnetic field.

The present embodiments include a rotor of an electrical machine having a first housing and at least one second housing (e.g., two housings). The at least one second housing is arranged in the interior of the first housing such that a cavity (e.g., an “intermediate space”) is formed between the first housing and the at least one second housing. The first housing and the at least one second housing may have a shape similar to a circular cylinder. A liquid cryogen is able to flow (e.g., “be guided”) through a first opening formed at the second housing into the interior of the second housing. The gaseous cryogen is then able to flow into the cavity between the two housings and escape from the interior of the second housing through a second opening formed at the second housing. The evaporated cryogen is able to flow out of the cavity and out of the first housing through a third opening formed at the first housing, whereby the cryogen is able to escape.

The present embodiments offer the advantage that the outer first housing is cooled from inside by the cryogen. A separate ventilator unit for cooling the outside wall of the rotor and the air gap may thus be omitted. Further, an insulating vacuum is not necessary, and a lighter construction of the outer first housing is thus possible.

In a further embodiment, the rotor may have a fourth opening formed at the first housing. The fourth opening is in operative connection with the first opening such that the liquid cryogen is able to flow into the second housing. For example, this may take place through a pipe guided through both openings.

In a further form, the rotor has a means (e.g., a structure), arranged in the cavity, that is configured to permit a flow of the cryogen in an axial direction and to interrupt a flow of the cryogen in a radial direction. This offers the advantage of preventing radially oriented convection cells. The structure, for example, may be formed, for example, of coaxial rings or have a honeycomb or tubular structure. The avoidance of thermal bridges usually leads to a filigree construction of many components, including connecting elements between the housings. In the case of the cryogenic cooling according to the present embodiments, the heat flow flowing via thermal bridges from the inner second housing to the outer first housing may be dissipated to the cryogen before the heat reaches the inner region (e.g., cryogenic region). Accordingly, the components connecting the second inner housing and the first outer housing may be of more robust construction. This is highly relevant for the torque transmission element, for example.

In a development, the cryogen may be hydrogen.

In a development, the rotor has rotary feedthroughs. A first rotary feedthrough has the first opening and the fourth opening. The first rotary feedthrough allows a substance (e.g., the liquid cryogen) to be introduced into the interior of the second body even while the rotor is rotating. A further rotary feedthrough allows a substance (e.g., the gaseous cryogen) to be removed from the gap between the first housing and the second housing even while the rotor is rotating.

The present embodiments also include an electrical machine with a rotor according to the present embodiments. The electrical machine may be a generator or a motor.

The present embodiments also include a device for cooling a rotor according to the present embodiments having a container that is in operative connection with the fourth opening and is configured to provide or to store the liquid cryogen.

In a further form, the device has at least one unit to be cooled that is able to be cooled by the evaporated cryogen after the evaporated cryogen has left the first housing. In addition or alternatively, the device in a further form has at least one fuel cell or at least one combustion engine that uses the evaporated cryogen as fuel after the evaporated cryogen has left the first housing.

The device offers the advantage that the cryogen is warmed to use temperature inside the machine. The provision of the separate heat source, which, for example, warms the hydrogen or another cryogen from the evaporating temperature to the use temperature (e.g., room temperature), may thus be omitted.

The present embodiments also include an aircraft having a device for cooling according to the present embodiments (e.g., for cooling an electric or hybrid-electric aircraft propulsion unit). The aircraft may be an airplane, the propeller of which, for propulsion, is set in rotation by the electrical machine.

Extensions with additional openings, additional housings, and/or other cryogens may be provided.

An aircraft may be any type of airborne device of locomotion or transportation, whether manned or unmanned.

The present embodiments also include a method for cooling a rotor according to the present embodiments of an electrical machine. The liquid cryogen flows into the second housing, the liquid cryogen evaporates in the second housing, the evaporated cryogen flows into the cavity, and the evaporated cryogen escapes from the first housing through the third opening.

### BRIEF DESCRIPTION OF THE DRAWINGS

FIG. 1 shows a longitudinal section through one embodiment of a rotor of an electrical machine;

FIG. 2 shows a longitudinal section through one embodiment of a rotor of an electrical machine having a honeycomb structure in a cavity between housings;

FIG. 3 shows a longitudinal section through one embodiment of a rotor of an electrical machine having coaxial rings in the cavity between the housings;

FIG. 4 shows a cross section through one embodiment of a rotor of an electrical machine having a tube structure in the cavity between the housings;

FIG. 5 shows a cross section through one embodiment of a rotor of an electrical machine having coaxial rings in the cavity between the housings;

FIG. 6 is a block diagram of one embodiment of a device for cooling an electrical machine having a rotor, a container in operative connection, and a further unit to be cooled or a combustion unit; and

FIG. 7 shows a view of one embodiment of an airplane.

### DETAILED DESCRIPTION

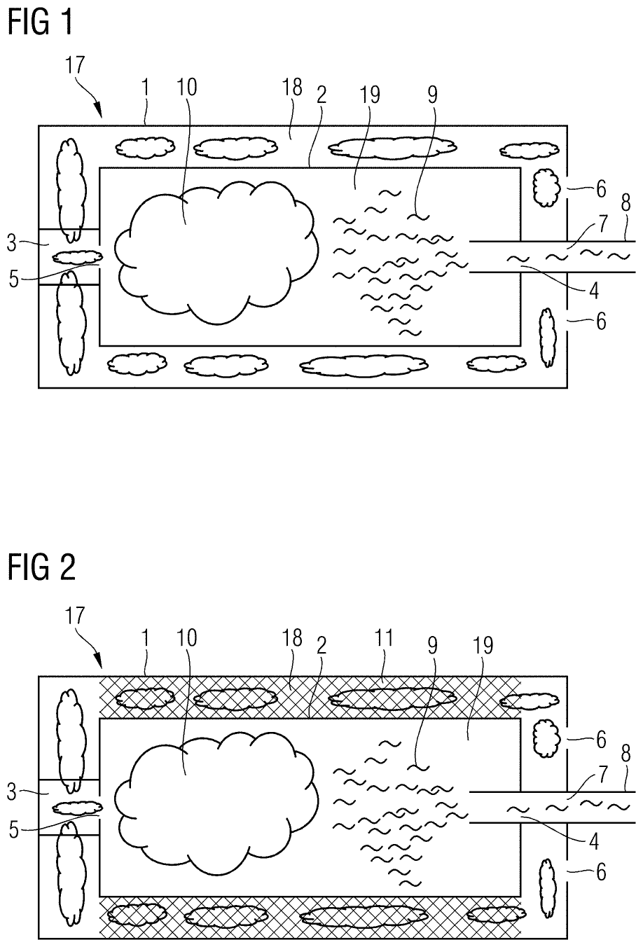

FIG. 1 shows a schematic illustration of exemplary cooling of a rotor 17 of an electrical machine in longitudinal section. FIG. 1 shows a first housing 1 that is outer relative to a second housing 2. The second housing 2 is located in an interior 19 of the first housing 1. The first housing 1 and the second housing 2 may each have a circular cylindrical shape, for example, and are may be arranged concentrically.

Between the first housing 1 and the second housing 2, there is a cavity 18. A torque transmission element 3 is formed on the first housing 1 and the second housing 2. This may be used to transmit rotation of the electrical machine to a propulsion unit (e.g., a propeller). A first opening 4 and a second opening 5 opposite the first opening 4 are located at the second housing 2, at end faces. A third opening 6 and a fourth opening 7 are located at the first housing 1, at an end face. The fourth opening 7 is in operative connection with the first opening 4 at the second housing 2 and is in the form of a rotary feedthrough 8.

Liquid cryogen 9 flows via the rotary feedthrough 8 into an interior 19 of the second housing 2. The liquid cryogen 9 may be hydrogen, for example. The liquid cryogen 9 warms up in the interior of the second housing 2 and becomes gaseous (e.g., gaseous cryogen 10). The gaseous cryogen 10 then leaves the second housing 2 through the second opening 5 and flows into the cavity 18 between the first housing 1 and the second housing 2.

In the cavity 18, the gaseous cryogen 10 takes up most of the heat flow entering from the warm outer first housing 1. The gaseous cryogen 10 then leaves the cavity 18 between the first housing 1 and the second housing 2 and may be fed to further uses. A pressure slightly above ambient pressure prevails in the cavity 18.

FIG. 2 shows an extension of FIG. 1. The extension, which is likewise shown in longitudinal section, contains a means (e.g., structure) arranged in the cavity 18. The structure includes a tube structure 11. Flow channels are present in a direction of the flowing gaseous cryogen 10 (e.g., in an axial direction of the rotor 17), but as little heat-conducting material and convection as possible is formed transversely to the axial direction in order to prevent heat transport from the outside to the inside through thermal bridges. Alternatively to the tube structure, a honeycomb structure, for example, may be provided.

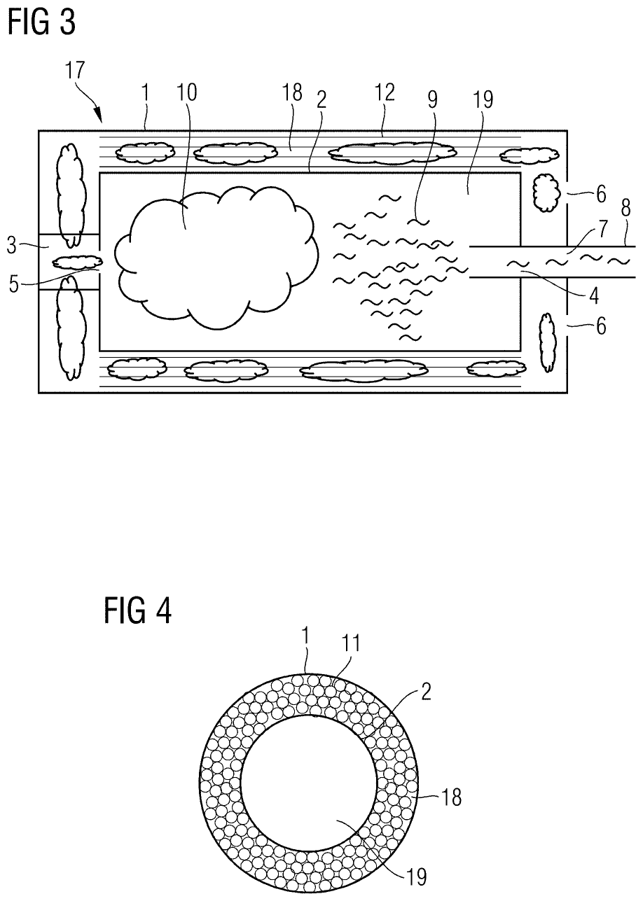

FIG. 3 shows an alternative extension to FIG. 2 of the rotor according to FIG. 1. The extension, which is likewise shown in longitudinal section, includes a means (e.g., a structure) in the form of coaxial rings 12 arranged in the cavity 18. The coaxial rings 18 are arranged axially concentrically around the second housing 2 and have spacers (not shown) for support in the cavity 18 or against one another.

FIG. 4 shows the cross section belonging to FIG. 2. FIG. 2 shows the first housing 1, the second housing 2, the tube structure 11 arranged in the cavity 18, and the interior 19. Alternatively to the tube structure, a honeycomb structure, for example, may be provided.

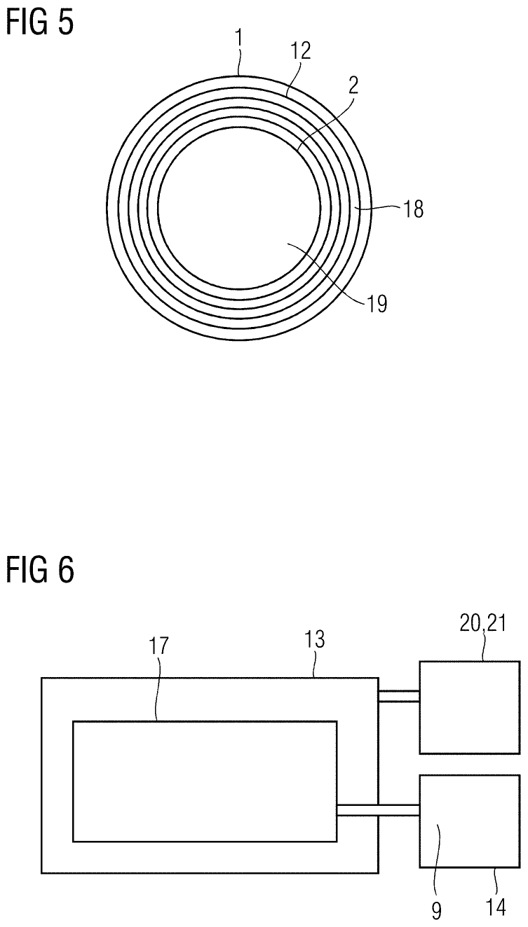

FIG. 5 shows the cross section belonging to FIG. 3. FIG. 5 shows the first housing 1, the second housing 2, the coaxial rings 12 arranged in the cavity 18, and the interior 19.

The heat input from the warm outside wall to the hydrogen gas owing to radially oriented convection cells is prevented. This may be achieved, for example, by a tube structure 11 that is introduced into the annular gap and through which flow takes place (FIG. 2 and FIG. 4), by coaxial rings 12 (FIG. 3 and FIG. 5), or by a honeycomb structure, which prevent radial convection.

FIG. 6 shows a block diagram of a device for cooling an electrical machine 13 having a rotor 17 according to FIG. 1, FIG. 2, or FIG. 3, and a container 14 connected thereto for providing a liquid cryogen 9. The device also includes a further unit 20 to be cooled or a fuel cell/internal combustion engine 21.

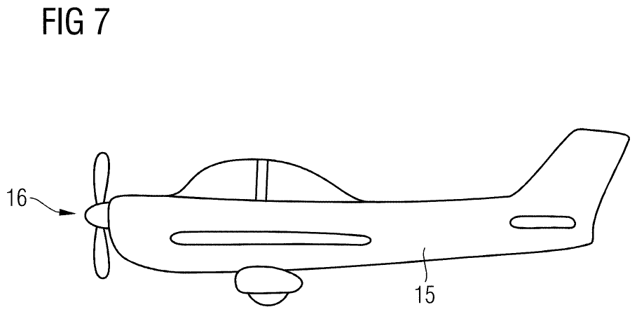

FIG. 7 is a view of an electric or hybrid-electric airplane 15 as an example of an aircraft. The electric or hybrid-electric airplane 15 includes an electrical machine 13 (not shown). The rotor 17 (not shown) of the electrical machine 13 sets a propeller 16 in rotation.

Although the invention has been described and illustrated more specifically in detail by exemplary embodiments, the invention is not restricted by the disclosed examples, and other variations may be derived therefrom by a person skilled in the art without departing from the scope of protection of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A rotor of an electrical machine, the rotor comprising:
a first housing;
a second housing arranged in an interior of the first housing, wherein a cavity is formed between the first housing and the second housing;
a first opening formed at the second housing, a liquid cryogen being flowable through the first opening into the second housing;
a second opening formed at the second housing, an evaporated cryogen being flowable through the second opening into the cavity; and
a third opening formed at the first housing, the evaporated cryogen being flowable through the third opening out of the cavity.

2. The rotor of claim 1, further comprising:
a fourth opening formed at the first housing, the fourth opening being in operative connection with the first opening such that the liquid cryogen is flowable into the second housing.

3. The rotor of claim 1, further comprising a structure, arranged in the cavity, that is configured to:
permit a flow of the evaporated cryogen in an axial direction; and
interrupt a flow of the evaporated cryogen in a radial direction, such that radially oriented convection cells are prevented.

4. The rotor of claim 3, wherein the structure is formed of coaxial rings or has a honeycomb structure.

5. The rotor of claim 1, wherein the liquid cryogen is liquid hydrogen.

6. An electrical machine comprising:
a rotor comprising:
a first housing;
a second housing arranged in an interior of the first housing, wherein a cavity is formed between the first housing and the second housing;
a first opening formed at the second housing, a liquid cryogen being flowable through the first opening into the second housing;
a second opening formed at the second housing, an evaporated cryogen being flowable through the second opening into the cavity;
a third opening formed at the first housing, the evaporated cryogen being flowable through the third opening out of the cavity;
a fourth opening formed at the first housing, the fourth opening being in operative connection with the first opening such that the liquid cryogen is flowable into the second housing; and
a rotary feedthrough having the first opening and the fourth opening.

7. A device for cooling a rotor of an electrical machine, the rotor comprising a first housing, a second housing arranged in an interior of the first housing, wherein a cavity is formed between the first housing and the second housing, the rotor further comprising a first opening formed at the second housing, a liquid cryogen being flowable through the first opening into the second housing, a second opening formed at the second housing, an evaporated cryogen being flowable through the second opening into the cavity, a third opening formed at the first housing, the evaporated cryogen being flowable through the third opening out of the cavity, and a fourth opening formed at the first housing, the fourth opening being in operative connection with the first opening such that the liquid cryogen is flowable into the second housing, the device comprising:
a container that is in operative connection with the fourth opening and is configured to provide the liquid cryogen.

8. The device of claim 7, further comprising:
at least one unit to be cooled that is coolable by the evaporated cryogen after the evaporated cryogen has left the first housing;
at least one fuel cell or at least one combustion engine configured to use the evaporated cryogen as fuel after the evaporated cryogen has left the first housing; or
a combination thereof.

9. An aircraft comprising:
a device for cooling a rotor of an electrical machine, the rotor comprising a first housing, a second housing arranged in an interior of the first housing, wherein a cavity is formed between the first housing and the second housing, the rotor further comprising a first opening formed at the second housing, a liquid cryogen being flowable through the first opening into the second housing, a second opening formed at the second housing, an evaporated cryogen being flowable through the second opening into the cavity, a third opening formed at the first housing, the evaporated cryogen being flowable through the third opening out of the cavity, and a fourth opening formed at the first housing, the fourth opening being in operative connection with the first opening such that the liquid cryogen is flowable into the second housing, the device comprising:
a container that is in operative connection with the fourth opening and is configured to provide the liquid cryogen.

10. The aircraft of claim 9, further comprising an electric or hybrid-electric aircraft propulsion unit.

11. The aircraft of claim 9, wherein the aircraft is an airplane.

12. The aircraft of claim 11, further comprising:
the electrical machine comprising the rotor;
a rotary feedthrough having the first opening and the fourth opening; and
a propeller that is settable in rotation by the electrical machine.

13. (canceled)

14. The rotor of claim 2, further comprising a structure, arranged in the cavity, that is configured to:
permit a flow of the evaporated cryogen in an axial direction; and
interrupt a flow of the evaporated cryogen in a radial direction, such that radially oriented convection cells are prevented.

15. The rotor of claim 14, wherein the structure is formed of coaxial rings or has a honeycomb structure.

16. The electrical machine of claim 6, wherein the rotor further comprises a structure, arranged in the cavity, that is configured to:
permit a flow of the evaporated cryogen in an axial direction; and
interrupt a flow of the evaporated cryogen in a radial direction, such that radially oriented convection cells are prevented.

17. The electrical machine of claim 16, wherein the structure is formed of coaxial rings or has a honeycomb structure.

18. The electrical machine of claim 6, wherein the liquid cryogen is liquid hydrogen.
